(19) United States
(12) Patent Application Publication
(10) Pub. No.: US 2008/0082431 A1
(43) Pub. Date: Apr. 3, 2008

(54) Method and system for managing foreign investment tax refunds

(76) Inventor: Gert D. Bekker, Marietta, GA (US)

Correspondence Address: LOWRIE, LANDO & ANASTASI, LLP, ONE MAIN STREET, SUITE 1100, CAMBRIDGE, MA, 02142, US

(21) Appl. No.: 11/521,978

(22) Filed: Sep. 15, 2006

(51) Int. Cl. G06F 17/22; G06Q 40/00; G07F 19/00

(52) U.S. Cl. 705/31; 705/36 T

(57) ABSTRACT

A method and system is provided for efficiently managing foreign investor tax refunds. In one embodiment, a method is employed to resolve disputed tax refund amounts and to direct automatic, electronic deposits of tax refunds to foreign accounts. This method may employ a computer based system to enable an accounting service provider to acquire tax information about foreign investors though the investor's contact with a fund initiator, to submit a tax return on behalf of a foreign investor, and to work with a financial institution to distribute electronically any refunds to the foreign investor.

### BACKGROUND OF INVENTION

1. Field of Invention

At least one embodiment of the invention is directed generally to a method and system used to process tax returns, and more specifically, to a method and system for managing and processing foreign investment tax returns.

2. Discussion of Related Art

In today's global economy, the amount of foreign capital invested in domestic concerns is substantial. In jurisdictions where tax is levied based upon income, profitable foreign investment results in domestic income tax liability. In such jurisdictions, a foreign investor may be required to work with several different entities, including fund initiators, taxing authorities, and financial institutions, to ensure that such tax liabilities are properly discharged and any refunds are received.

A particular example of a jurisdiction where tax is levied based upon income is the United States. Before targeting the United States, it is common for foreign investors to pool their financial resources into collective investment entities. These entities, known as fund initiators, seek to invest in profitable domestic ventures. If the fund initiators are successful, the profits recognized result in federal and state tax liability to their constituent foreign investors.

To comply with the federal and state tax laws while aiding their foreign investors to discharge their tax liabilities, fund initiators typically withhold and pay a portion of their foreign investors' profits to taxing authorities, e.g. the Internal Revenue Service (IRS). Many fund initiators also prepare tax year end returns on behalf of their foreign investors. These returns often result in some portion of the previously withheld profits being returned to the foreign investors in the form of tax refunds. Once these tax refunds are received by the foreign investors, they are frequently deposited with the foreign investors' financial institutions of choice.

Unfortunately, this tax refund process suffers from inefficiencies causing the foreign investor typically to be involved unnecessarily. Also, taxing authorities in the United States do not allow for electronic deposit of the foreign investor's tax refunds into foreign accounts. While certain financial institutions have created virtual domestic accounts that are linked with foreign accounts in an attempt to ameliorate this issue, management of these accounts still requires substantial effort.

### SUMMARY OF INVENTION

There is a need to efficiently manage foreign investment tax refunds. For example, a process capable of resolving disputed tax refund amounts while involving only the necessary parties and directing automatic, electronic deposits of tax refunds to accounts per foreign investor instructions would decrease the effort required to ensure the amount of tax paid and refunded is correct.

According to one aspect of the invention, a method is provided for managing tax refunds. The method includes acquiring foreign investor tax information, sending the foreign investor tax information to a financial institution, preparing a tax return using the foreign investor tax information, outputting the tax return for filing with a taxing authority, acquiring a tax refund deposit notification, describing a tax refund, from the financial institution, and determining any inadequacies in the tax refund.

In the method, acquiring foreign investor tax information may include acquiring foreign investor tax information from a fund initiator, and sending the foreign investor tax information to a financial institution may include sending the foreign investor tax information to a financial institution to create a virtual account. The method may further include resolving any inadequacies in the tax refund, and directing distribution of the tax refund according to the foreign investor tax information. In the method, acquiring foreign investor tax information may include acquiring an Individual Tax Identification Number. In the method, determining any inadequacies in the tax refund may include comparing the tax refund against at least one expected value. In the method, directing distribution of the tax refund may further include determining if the tax refund is transferred successfully according to the foreign investor tax information, correcting the foreign investor tax information corresponding to the tax refund if the tax refund did not transfer successfully, and instructing the financial institution to transfer the tax refund according to the foreign investor tax information. Still further, in the method, directing distribution of the tax refund may include instructing the financial institution to withhold a fee.

According to another aspect of the invention, a computer-readable medium is provided having computer-readable signals stored thereon that define instructions that, as a result of being executed by a processor, instruct the processor to perform a method for managing foreign investor tax refunds. The method includes acquiring foreign investor tax information, sending the foreign investor tax information to a financial institution, obtaining a tax return using the foreign investor tax information, outputting the tax return for filing with a taxing authority, acquiring a tax refund deposit notification, describing a tax refund, from the financial institution, and determining any inadequacies in the tax refund.

In the instructions on the computer-readable medium, acquiring foreign investor tax information may include acquiring foreign investor tax information from a fund initiator, and sending the foreign investor tax information to a financial institution may include sending the foreign investor tax information to a financial institution to create a virtual account. The method defined on the medium may further include presenting any inadequacies in the tax refund for resolution, and directing distribution of the tax refund according to the foreign investor tax information. In the method, acquiring foreign investor tax information may include acquiring an Individual Tax Identification Number, and determining any inadequacies in the tax refund may include comparing the tax refund against at least one expected value. In the method, directing distribution of the tax refund may further include determining if the tax refund transferred successfully in a previous distribution according to the foreign investor tax information, presenting the foreign investor tax information corresponding to the tax refund for correction if the tax refund did not transfer successfully in a previous distribution, and instructing the financial institution to transfer the tax refund according to the foreign investor tax information. In the method, directing distribution of the tax refund may include instructing the financial institution to withhold a fee.

According to another aspect of the invention, a system is provided for managing tax refunds. The system includes at least one input to receive foreign investor tax information and to receive virtual account transaction information from a financial institution, at least one module adapted to obtain a tax return using the foreign investor tax information, monitor the virtual account transaction information for a tax refund deposit notification, which describes a tax refund, and determine any inadequacies in the tax refund, and at least one output adapted to provide the foreign investor tax information to the financial institution and to provide the tax return for filing with a tax authority.

In the system, the at least one module may be further adapted to present any inadequacies in the tax refund for resolution, and prepare a tax refund distribution instruction, describing how to transfer the tax refund, according to the foreign investor tax information. In the system, the at least one input to receive foreign investor tax information may be further adapted to receive an Individual Tax Identification Number. Further, in the system, the at least one module may be adapted to determine any inadequacies in the tax refund and be further adapted to compare the tax refund against at least one expected value. In the system, the at least one module may be adapted to prepare a tax refund distribution instruction and may be further adapted to determine if the tax refund transferred successfully in a previous distribution according to the foreign investor tax information, present the foreign investor tax information corresponding to the tax refund for correction if the tax refund did not transfer successfully in a previous distribution, and prepare the tax refund distribution instruction according to the foreign investor tax information. In the system, the at least one output may be adapted to provide the tax refund distribution instruction and be further adapted to provide an instruction to the financial institution to withhold a fee.

Further features and advantages of the present invention as well as the structure and operation of various embodiments of the present invention are described in detail below with reference to the accompanying drawings.

### BRIEF DESCRIPTION OF THE DRAWINGS

This invention is pointed out with particularity in the appended claims. The above and further advantages of this invention may be better understood by referring to the following description when taken in conjunction with the accompanying drawings in which similar reference numbers indicate the same or similar functional elements.

In the drawings,

FIG. 1 is a flow chart of a process for managing foreign investor tax refunds according to one embodiment of the invention;

FIG. 2 shows, in context, a system capable of managing foreign investor tax refunds in accordance with one embodiment of the invention;

FIG. 3 shows a general-purpose computer system upon which various embodiments of the invention may be practiced;

FIG. 4 illustrates a storage device of a general-purpose computer system; and

FIG. 5 depicts a network of general-purpose computer systems.

### DETAILED DESCRIPTION

At least one aspect of the present invention relates to managing foreign tax investment refunds.

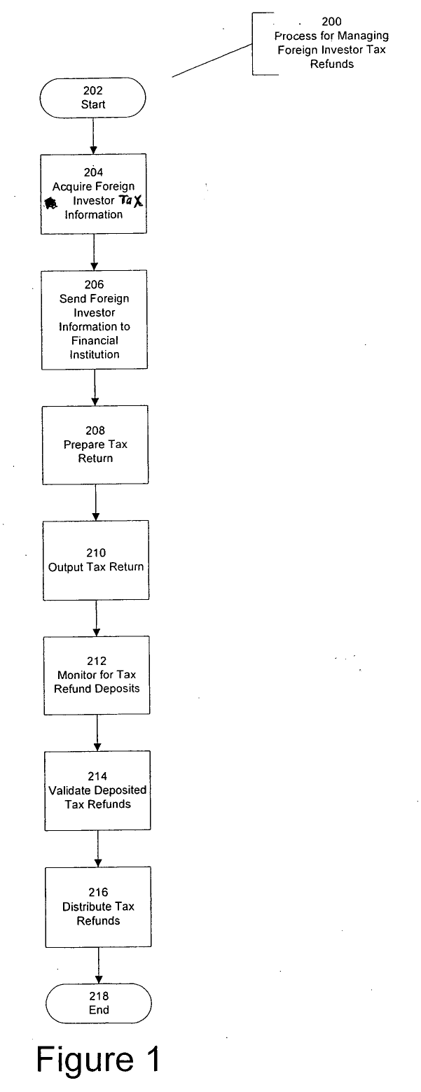

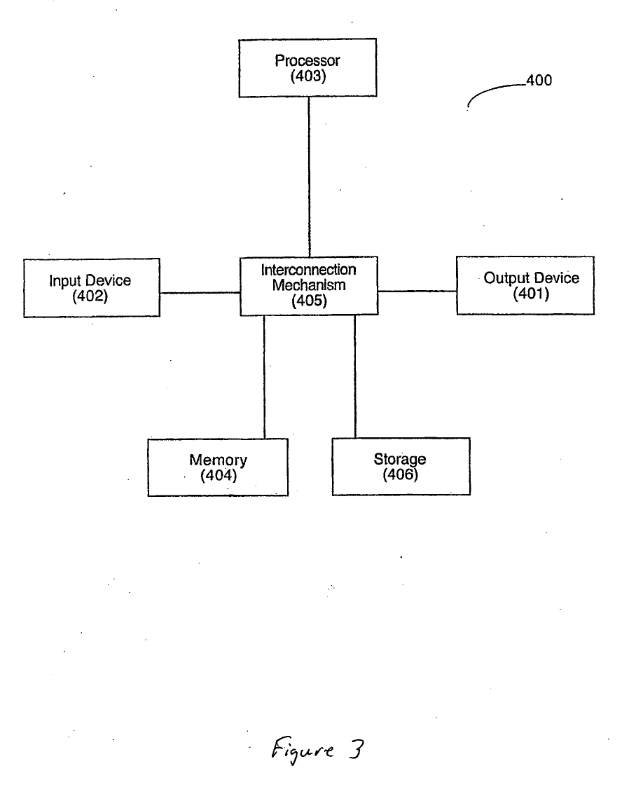

FIG. 1 shows an example process for managing foreign investment tax refunds according to one embodiment of the present invention. This process may be implemented using a general-purpose computer system as discussed with regard to FIG. 3 below. At block 202, process 200 begins. At block 204, tax information pertaining to the foreign investor is acquired from a fund initiator. This tax information may be acquired directly from a fund initiator, or may be acquired indirectly from the fund initiator through its client list, i.e. using the list to acquire foreign investor tax information from each foreign investor. In particular, the tax information acquired may include the foreign investor's contact information (name, address, etc. . . .), tax identification information (Individual Tax Identification Number (ITIN), number of visits inside the US, number of US visas held, US Citizenship information), income related to investments inside the US and tax refund method of payment preferences. If the tax refund method of payment preference is electronic, additional tax information acquired may include account holder, routing code, account number, deposit instructions, bank name, and deposit currency.

At block 206, for each foreign investor whose tax refund method of payment preference is electronic, the tax information required for maintenance of a virtual account is sent to a financial institution. Maintenance of these virtual accounts includes initial setup, entry of foreign investor tax information such as specified by block 204 above, and update to such information for previously setup foreign investors. It is to these virtual accounts that taxing authorities will be instructed to electronically deposit the foreign investors' tax refunds.

At block 208, once all of the information required to file a tax return has been acquired for a foreign investor, a tax return is prepared for the foreign investor. In one embodiment, the information is input into a tax preparation system, and the tax preparation system generates a tax return for the foreign investor. For instance, one embodiment of the invention generates a Federal Form 1040NR.

At block 210, the tax return is output for submission to the taxing authority. For example, current IRS practice requires that a hardcopy of Form 1040NR be submitted to the IRS. State forms are submitted to the appropriate state taxing authority. It should be appreciated, that in other embodiments in accord with the present invention, the tax return may be generated, stored and forwarded to a taxing authority for filing electronically.

At block 212, each foreign investor's virtual account is monitored for tax refund deposits notifications. In one embodiment, this monitoring is accomplished by reviewing the transaction log for a virtual account for any new activity. This review may be conducted, for example, via the internet through a browser-based user interface into the transaction log for a virtual account. Hence, the transaction log serves as the tax refund deposit notification.

At block 214, for each tax refund deposited into a virtual account, the deposited tax refund is validated against an expected tax refund. In accordance with one embodiment of the present invention, the following deposited tax refund information is checked against the expected tax refund: the ITIN, the name, the amount, and if this is the first time this tax refund has been received. In other embodiments, more or less information may be verified. If the deposited tax refund ITIN or name do not match the expected tax refund, the deposited refund is marked as an exception. If a discrepancy exists between the deposited tax refund amount and the expected tax refund amount that exceeds an acceptable range, the refund is marked as an exception. If this is not the first time that this deposited tax refund has been deposited and the previous deposited tax refunded was successfully distributed per foreign investor instructions, this deposited tax refund is marked as an exception. The grounds for marking as an exception any deposited tax refund are addressed with the appropriate taxing authority prior to its being scheduled for distribution. All deposited tax refunds that are not marked as exceptions are scheduled for distribution based on the foreign investor tax information acquired in block 204.

At block 216, the tax refunds are distributed per foreign investor instructions. This distribution may be a solitary tax refund transfer from one bank account to another or may be several such tax refund transfers. For each tax refund transfer scheduled in a distribution, the financial institution is instructed to transfer the tax refund, less fees, to an account as specified by the foreign investor tax information acquired in block 204. For example, the list of tax refunds and foreign investor instructions may take the form of a hardcopy or an email, and the financial institution may effect the transfer through established processes known in the art. Any transfers that are not successfully completed are marked as an exception. The grounds for the exceptions are resolved and the transfers are scheduled for next distribution. For instance, a failed transfer due to an incorrect routing number will result in correction of the routing number and inclusion of the tax refund on the list for the next distribution. At block 218, process 200 ends.

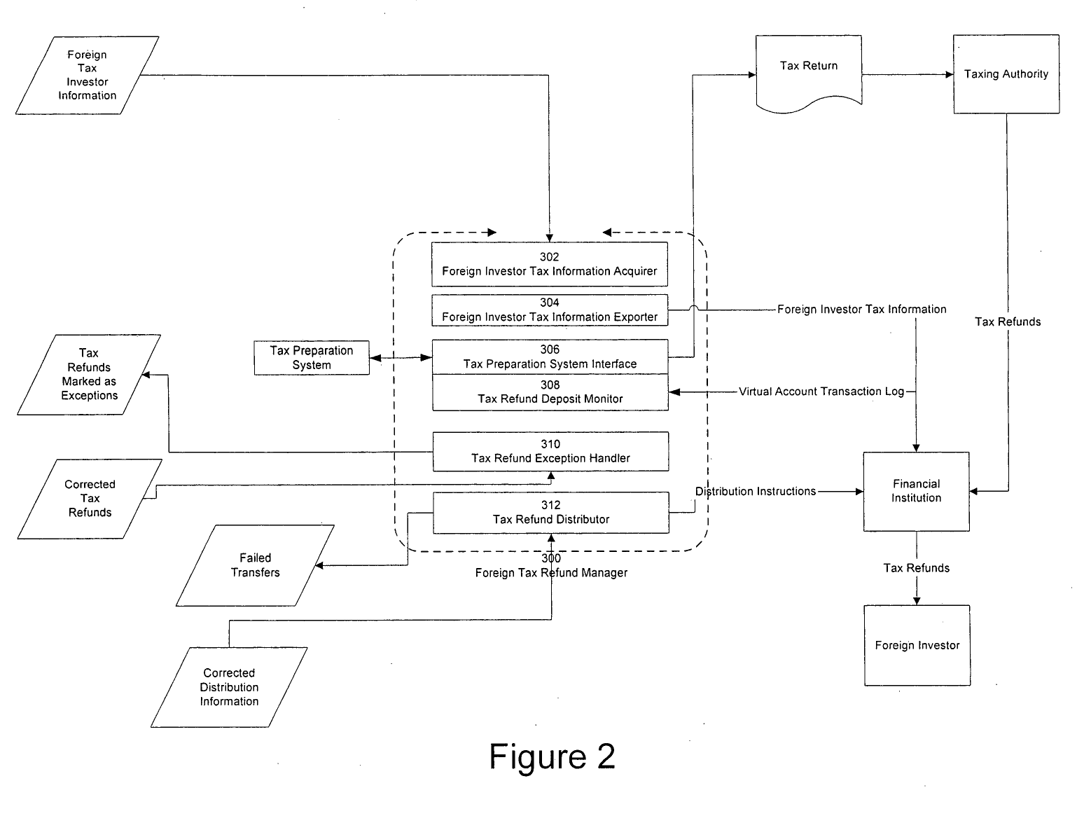

FIG. 2 illustrates a system 300 for managing foreign investment tax refunds according to one embodiment of the invention when implemented on one or more computer systems. Any of the recited modules may be implemented in customized software code or using existing software including a GUI, email, FTP, batch system interface, database system data movement tools, middleware, scanning with optical character recognition (OCR), any combination thereof, or otherwise. Moreover, embodiments in accord with the present invention may adopt any modular structure and are not limited to those shown in FIG. 2. The particular modular arrangement presented in FIG. 2 was chosen to promote clarity.

System 300 may include a foreign investor tax information acquirer module 302, a foreign investor tax information exporter module 304, a tax preparation system interface module 306, a tax refund deposit monitor module 308, a tax refund exception handler module 310, and a tax refund distributor module 312. Module 302 supplies modules 304, 306, 308, 310, and 312 with foreign investor tax information. Module 304 accepts foreign investor tax information from Module 302. Module 306 accepts foreign investor tax information from Module 302 and supplies expected tax refund information to Module 310. Module 308 accepts foreign investor tax information from Module 302 and supplies deposited tax refund information to Module 310. Module 310 accepts foreign investor tax information from Module 302, expected tax refund information from Module 306 and deposited tax refund information from Module 308. Module 310 supplies deposited tax refund exception information to Module 312. Module 312 accepts foreign investor tax information from Module 302 and deposited tax refund exception information from Module 310.

Module 302 acquires the foreign investor tax information such as that discussed above with reference to Block 204 of FIG. 1. In one embodiment, foreign investor names and ITIN's may be scanned into the system with a commercial available OCR product, while any remaining foreign investor tax information may be manually keyed into the system through a custom implemented browser-based data entry screen. Alternatively, the system may import this information from an encrypted data stream or from encrypted data files on a storage device.

Module 304 sends the foreign investor tax information to a financial institution. For instance, foreign investor tax information may be exported from a database, using database system data movement tools, into a format specified by the financial institution's batch system interface prior to being transferred via FTP. Alternatively, the information could be rendered into XML.

Module 306 interfaces with a tax preparation system. In an embodiment, this interface may maintain, i.e. keep current, foreign investor tax information within the tax preparation system, schedule tax preparation system operation, receive prepared tax returns from the tax preparation system and output the tax return for filing with a taxing authority. The current practice of taxing authorities inside the US requires that a hardcopy of at least some of these tax returns be submitted. At least some embodiments, however, may output the tax return electronically.

Module 308 monitors each foreign investor's virtual account for tax refund deposits. In one embodiment, the financial institution maintains an electronic virtual account transaction log, which may be recorded in MT940 format. Periodically, module 308 electronically reviews this transaction log for new account activity such as deposited tax refunds. When such a new deposit is noted, module 308 passes this information to module 310.

Module 310 validates deposited tax refunds against expected tax refunds as discussed above, for example, with reference to FIG. 1, Block 214. Any tax refunds marked as an exception are presented for resolution. For example, the tax refunds marked as an exception may be presented to a user by a printed report, email, or GUI. It should be appreciated that, in accordance with the present invention, tax refunds marked as an exception may be presented to another module or system for resolution through a system interface or similar conduit. Finally, all tax refunds that are not marked as an exception are scheduled for distribution per foreign investor tax information. In an embodiment, weekly distributions are scheduled automatically with a financial institution.

Module 312 directs a financial institution's systems to distribute tax refunds to the account specified by the foreign investor tax information. In one embodiment, this distribution instruction may take the form of either an AUS transaction or an AZV transaction, depending on the type and amount of currency distributed. Fees may be withheld automatically. Tax refund transfers that fail to reach the account specified by the foreign investor tax information are presented for resolution. For example, unsuccessful tax refund transfers may be presented to a user by a printed report, email, or GUI. It should be appreciated that, in accordance with the present invention, failed tax refund transfers may be presented to another module or system for resolution through a system interface or similar conduit. Once the reason for the failure is resolved, the tax refund may be scheduled for the next distribution.

The modular structure and content recited above is for exemplary purposes only and is not intended to limit the invention to the specific structure disclosed. As will be apparent to one of ordinary skill in the art, many variant modular structures can be architected without deviating from the present invention.

A process for managing foreign investment tax refunds 200 according to one embodiment of the invention may be implemented on one or more general-purpose computer systems. For example, various aspects of the invention may be implemented as specialized software executing in a general-purpose computer system 400 such as that shown in FIG. 3. Computer system 400 may include one or more output devices 401, one or more input devices 402, a processor 403 connected to one or more memory devices 404 through an interconnection mechanism 405 and one or more storage devices 406 connected to interconnection mechanism 405. Output devices 401 typically render information for external presentation and examples include a monitor and a printer. Input devices 402 typically accept information from external sources and examples include a keyboard and a mouse. Processor 403 typically performs a series of instructions resulting in data manipulation. Processor 403 is typically a commercially available processor such as an Intel Pentium, Motorola PowerPC, SGI MIPS, Sun UltraSPARC, or Hewlett-Packard PA-RISC processor, but may be any type of processor. Memory devices 404, such as a disk drive, memory, or other device for storing data is typically used for storing programs and data during operation of the computer system 400. Devices in computer system 400 may be coupled by at least one interconnection mechanism 405, which may include, for example, one or more communication elements (e.g., busses) that communicate data within system 400.

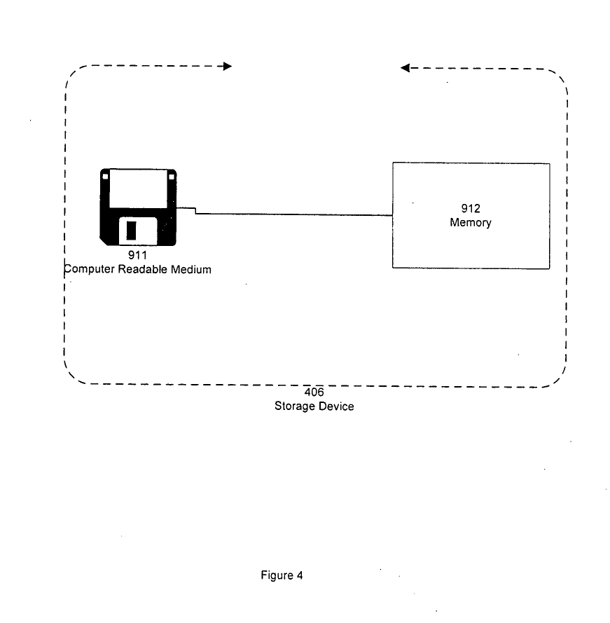

The storage device 406, shown in greater detail in FIG. 4, typically includes a computer readable and writeable nonvolatile recording medium 911 in which signals are stored that define a program to be executed by the processor or information stored on or in the medium 911 to be processed by the program. The medium may, for example, be a disk or flash memory. Typically, in operation, the processor causes data to be read from the nonvolatile recording medium 911 into another memory 912 that allows for faster access to the information by the processor than does the medium 911. This memory 912 is typically a volatile, random access memory such as a dynamic random access memory (DRAM) or static memory (SRAM). It may be located in storage device 406, as shown, or in memory device 404. The processor 403 generally manipulates the data within the memory 404, 912 and then copies the data to the medium 911 after processing is completed. A variety of mechanisms are known for managing data movement between the medium 911 and the memory 404, 912, and the invention is not limited thereto. The invention is not limited to a particular memory device 404 or storage device 406.

Computer system 400 may be implemented using specially programmed, special purpose hardware, or may be a general-purpose computer system that is programmable using a high-level computer programming language. Computer system 400 usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX operating systems available from various sources (e.g., Linux). Many other operating systems may be used, and the invention is not limited to any particular implementation. For example, an embodiment of the present invention may instruct financial institutions to distribute tax refunds using a general-purpose computer system with a Sun UltraSPARC processor running the Solaris operating system.

Although computer system 400 is shown by way of example as one type of computer system upon which various aspects of the invention may be practiced, it should be appreciated that the invention is not limited to being implemented on the computer system as shown in FIG. 3. Various aspects of the invention may be practiced on one or more computers having a different architecture or components than that shown in FIG. 3. To illustrate, one embodiment of the present invention may acquire foreign investor tax information using several general-purpose computer systems running MAC OS System X with Motorola PowerPC processors and several specialized computer systems running proprietary hardware and operating systems.

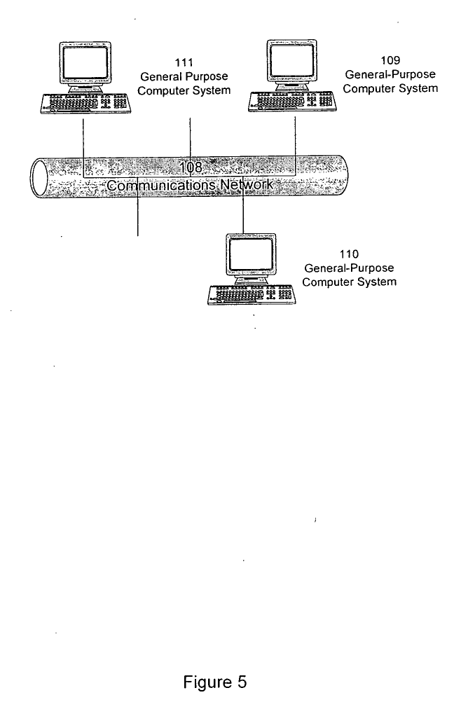

As depicted in FIG. 5, one or more portions of the system may be distributed to one or more computers (e.g., systems 109-111) coupled to communications network 108. These computer systems 109-111 may also be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). To illustrate, one embodiment may acquire foreign investor tax information though a browser interpreting HTML forms and may interface with a tax preparation system using a data translation service running on a separate server.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. For example, a foreign investor tax information data entry screen may be implemented using Visual Basic while the application designed to monitor for tax refund deposits may be written in C++.

It should be appreciated that a general-purpose computer system in accord with the present invention may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and WebSphere middleware from IBM of Armonk, N.Y. If SQL Server is installed on a general-purpose computer system to implement an embodiment of the present invention, the same general-purpose computer system may be able to support databases for sundry applications.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, whether in the written description or the claims, the terms “comprising”, “including”, “carrying”, “having”, “containing”, “involving”, and the like are to be understood to be open-ended, i.e., to mean including but not limited to.

What is claimed is:

1. A method for managing tax refunds comprising:
acquiring foreign investor tax information;
sending the foreign investor tax information to a financial institution;
preparing a tax return using the foreign investor tax information;
outputting the tax return for filing with a taxing authority;
acquiring a tax refund deposit notification, describing a tax refund, from the financial institution; and
determining any inadequacies in the tax refund.

2. The method according to claim 1, wherein
acquiring foreign investor tax information comprises acquiring foreign investor tax information from a fund initiator; and
sending the foreign investor tax information to a financial institution comprises sending the foreign investor tax information to a financial institution to create a virtual account.

3. The method according to claim 2, further comprising:
resolving any inadequacies in the tax refund; and
directing distribution of the tax refund according to the foreign investor tax information.

4. The method according to claim 3, wherein acquiring foreign investor tax information comprises acquiring an Individual Tax Identification Number.

5. The method according to claim 4, wherein determining any inadequacies in the tax refund comprises comparing the tax refund against at least one expected value.

6. The method according to claim 5, wherein directing distribution of the tax refund comprises
determining if the tax refund is transferred successfully according to the foreign investor tax information;
correcting the foreign investor tax information corresponding to the tax refund if the tax refund did not transfer successfully; and
instructing the financial institution to transfer the tax refund according to the foreign investor tax information.

7. The method according to claim 6, wherein directing distribution of the tax refund comprises instructing the financial institution to withhold a fee.

8. A computer-readable medium having computer-readable signals stored thereon that define instructions that, as a result of being executed by a processor, instruct the processor to perform a method for managing tax refunds comprising the acts of:
acquiring foreign investor tax information;
sending the foreign investor tax information to a financial institution;
obtaining a tax return using the foreign investor tax information;
outputting the tax return for filing with a taxing authority;
acquiring a tax refund deposit notification, describing a tax refund, from the financial institution; and
determining any inadequacies in the tax refund.

9. The computer-readable medium according to claim 8, wherein
acquiring foreign investor tax information comprises acquiring foreign investor tax information from a fund initiator; and
sending the foreign investor tax information to a financial institution comprises sending the foreign investor tax information to a financial institution to create a virtual account.

10. The computer-readable medium according to claim 9, the method for managing tax refunds further comprising:
presenting any inadequacies in the tax refund for resolution; and
directing distribution of the tax refund according to the foreign investor tax information.

11. The computer-readable medium according to claim 10, wherein acquiring foreign investor tax information comprises acquiring an Individual Tax Identification Number.

12. The computer-readable medium according to claim 11, wherein determining any inadequacies in the tax refund comprises comparing the tax refund against at least one expected value.

13. The computer-readable medium according to claim 12, wherein directing distribution of the tax refund comprises:
determining if the tax refund transferred successfully in a previous distribution according to the foreign investor tax information;
presenting the foreign investor tax information corresponding to the tax refund for correction if the tax refund did not transfer successfully in a previous distribution; and
instructing the financial institution to transfer the tax refund according to the foreign investor tax information.

14. The computer-readable medium according to claim 13, wherein directing distribution of the tax refund comprises instructing the financial institution to withhold a fee.

15. A system for managing tax refunds, the system comprising:
at least one input to receive foreign investor tax information and to receive virtual account transaction information from a financial institution;
at least one module adapted to obtain a tax return using the foreign investor tax information, monitor the virtual account transaction information for a tax refund deposit notification, which describes a tax refund, and determine any inadequacies in the tax refund;
at least one output adapted to provide the foreign investor tax information to the financial institution and to provide the tax return for filing with a tax authority.

16. The system according to claim 15 wherein the at least one module is further adapted to:
present any inadequacies in the tax refund for resolution, and
prepare a tax refund distribution instruction, describing how to transfer the tax refund, according to the foreign investor tax information;
wherein the at least one output is adapted to provide the tax refund distribution instruction to the financial institution.

17. The system according to claim 16, wherein the at least one input to receive foreign investor tax information is further adapted to receive an Individual Tax Identification Number.

18. The system according to claim 17, wherein the at least one module adapted to determine any inadequacies in the tax refund is further adapted to compare the tax refund against at least one expected value.

19. The system according to claim 18, wherein the at least one module adapted to prepare a tax refund distribution instruction is further adapted to:
determine if the tax refund transferred successfully in a previous distribution according to the foreign investor tax information;
present the foreign investor tax information corresponding to the tax refund for correction if the tax refund did not transfer successfully in a previous distribution; and
prepare the tax refund distribution instruction according to the foreign investor tax information.

20. The system according to claim 19, wherein the at least one output adapted to provide the tax refund distribution instruction is further adapted to provide an instruction to the financial institution to withhold a fee.
